(19) United States
(12) Patent Application Publication
(10) Pub. No.: US 2012/0079936 A1
(43) Pub. Date: Apr. 5, 2012

(54) POSITIVE DISPLACEMENT MACHINE PISTON WITH WAVY SURFACE FORM

(75) Inventors: Monika Marianne Ivantysynova, Lafayette, IN (US); Reece Alan Garrett, West Lafayette, IN (US); Andrew A. Fredrickson, Raleigh, NC (US)

(73) Assignee: PURDUE RESEARCH FOUNDATION, West Lafayette, IN (US)

(21) Appl. No.: 13/260,649

(22) PCT Filed: Apr. 1, 2010
(86) PCT No.: PCT/US10/29647

§ 371 Date: Nov. 23, 2011

(30) Foreign Application Priority Data
Apr. 1, 2009 (US) 61165661

(51) Int. Cl. F04B 53/14; B23P 15/00

(52) U.S. Cl. 92/174; 29/888.02

(57) ABSTRACT

A piston and cylinder assembly suitable for use in positive displacement machines (10) and capable of minimizing power losses resulting from friction and fluid leakage over a range of operating parameters. The piston (14) is reciprocably disposed within a cylinder (16) having a uniform diameter. The piston (14) has a bearing surface (30) that defines a diametrical clearance with the cylindrical bearing surface of the cylinder (16) of up to about two percent of the cylinder diameter. The diametrical clearance defines a lubrication gap (26) and a hydrodynamic seal between the piston (14) and the cylinder (16). The piston (14) further has alternating crests (34) and valleys (36) defined in a nominally cylindrical shape (28) of its bearing surface (30). The crests (34) and valleys (36) are oriented and spaced on the bearing surface (30) to define a wavy surface form (32) along the entire axial length of the bearing surface (30).

### BACKGROUND OF THE INVENTION

The present invention generally relates to fluid pumps and motors, and more particularly to piston and cylinder assemblies suitable for use in positive displacement machines.

Useful hydrostatic pumps and motors have been around since the early 1800's and the concepts used in these early machines can be traced back even further. Though there are many types of hydrostatic pumps and motors, piston-type hydrostatic pumps and motors gained popularity in the early to mid 1900's as systems tended toward higher operating pressures. Positive displacement machines, such as axial and radial piston pumps and motors of swash plate design, have been widely used since the 1950's. Axial piston pumps and motors are quite versatile because, in addition to their variable displacement capability, they are capable of operating at high pressures level and their input and output shafts are collinear, resulting in a compact unit that can be readily implemented in a variety of fluid power systems.

Axial and radial piston machines generally comprise an array of cylindrical-shaped pistons that reciprocate within cylindrical bores (hereinafter, simply referred to as cylinders) within a cylinder block. In axial piston machines, the piston-cylinder combinations are parallel and arranged in a circular array within the cylinder block. An inlet/outlet port is defined at one end the cylinder block for each individual piston-cylinder combination, such that a fluid can be drawn into and expelled from each cylinder through the port as the piston within the cylinder is reciprocated. The end of the cylinder block containing the inlet/outlet ports defines an axial sliding bearing surface that abuts a surface of a valve plate, while the opposite end of the cylinder block is connected to a drive shaft for rotation of the cylinder block. The valve plate defines an inlet opening and an outlet opening that are sequentially aligned with the inlet/outlet of each cylinder, so that fluid is drawn into each cylinder through the cylinder's inlet/outlet port when aligned with the valve plate inlet opening and expelled from each cylinder through the cylinder's inlet/outlet port when aligned with the valve plate outlet opening.

One end of each piston protrudes from the cylinder block and is coupled with a stationary swash plate inclined to the axis of the cylinder block, causing the pistons to reciprocate within the cylinder block as the block is rotated relative to the swash plate. The stroke length of each piston, and therefore displacement of the piston-cylinder combinations, can be made variable by changing the inclination (cam angle) of the swash plate. To provide this capability, the protruding end of each piston may be configured to have a ball-and-socket arrangement. The socket portion of this arrangement, or slipper, may have a planar surface that bears against the swash plate. The spherical mating surfaces of each piston-slipper combination and the planar mating surfaces of the swash plate and each slipper define axial sliding bearing surfaces, which are separated by a fluid film formed with, for example, the fluid being worked on. The resulting hydrostatic axial sliding bearings transfer the piston force to the swash plate during relative motion between the slipper and swash plate.

The mating cylindrical surfaces of each piston and cylinder assembly are also sliding bearing surfaces separated by a film formed by the fluid being worked on by the machine. This film is within a lubrication gap determined by the diametrical clearance between the piston and cylinder, and serves as a sliding bearing between the piston and the cylinder. Conventional axial piston machines lack sealing elements between their pistons and cylinders, and therefore the fluid film within the lubrication gap also serves as a hydrodynamic seal to minimize fluid leakage between the piston and the cylinder. Consequently, the sliding bearing surfaces of the piston and cylinder have both a bearing function and a sealing function, which differentiates piston-cylinder sliding bearings of axial piston machines from typical bearing applications that have only a load-bearing function.

The efficiencies of machines with sliding bearing surfaces are dependent on the torque losses attributable to each sliding bearing surface. For positive displacement machines, efficiencies are also dependent on power losses attributable to fluid leakage between the sliding bearing surfaces of the cylinder block and valve plate and each piston and cylinder assembly. Designs for sliding bearings are widely known and described in the literature. Design principles and calculation methods typically assume that the lubrication gap between the sliding bearing surfaces of a piston and its cylinder is uniform as a result of the piston and cylinder being concentric. It is also common practice to allow a minimum surface roughness, typically less than a one micrometer Ra and more typically in a range of thousandths to tenths of a micrometer, requiring an abrasive finishing operation.

The lubrication and sealing effectiveness achieved by the fluid film are subject to variations in the thickness of the film resulting from the piston being subjected to off-axis eccentric loads as the orientation of the cylinder block varies in relation to the valve plate in order to change the stroke length of the pistons and displaced fluid volume. Consequently, the bearing and sealing functions performed by the sliding bearing surfaces of the piston and cylinder are complicated by the operation of the variable displacement machines in which they operate. In particular, as a result of off-axis eccentric loading of the piston during reciprocation within its cylinder, the bearing surface of the piston is inclined with respect to the bearing surface of its cylinder, forming a lubrication gap of variable height and leading to hydrodynamic effects. Relative inclination of the bearing surfaces can lead to conditions with very low gap heights on one side and very high gap heights on the diametrically opposite side of the piston. Such conditions increase friction in areas of relatively small gap heights and increase leakage in locations of relatively large gap heights, resulting in increased power losses of the machine and reduced machine efficiency.

As the cost of energy increases, the efficiency of positive displacement machines is becoming an important topic of study. Although positive displacement machines can be quite efficient at one specific set of operating parameters, they are not very efficient over a broad range of operating parameters, which can be a hindrance for emerging fluid power systems such as displacement control technology or hydraulic hybrid vehicles. The success of these systems depends heavily on the availability of variable displacement pumps and motors that are highly efficient at both high and low displacements. In order to build valid models for designing new pumps and motors, it is necessary to understand the pertinent physical effects occurring within these machines. This is especially true of the very narrow lubrication gaps between the pistons and cylinders of axial piston pumps and motors, since these gaps are where a significant amount of energy is lost as a result of being dissipated through friction and leakage. Though equations and models used to describe the flow through the lubrication gap between a piston and cylinder are known, including the modeling of pressure buildup in a viscous fluid flowing between two nonparallel surfaces that have relative motion, the accuracy of such models must usually be evaluated using experimental results.

In view of the above, there is a desire to minimize power losses resulting from friction and/or fluid leakage in variable displacement axial piston machines, as well as other machines that rely on the mating surfaces of a piston and cylinder assembly to provide both bearing and sealing functions. It would be further desirable if such axial piston pumps and motors were more efficient, more compact, and quieter over a large range of operating parameters.

### BRIEF DESCRIPTION OF THE INVENTION

The present invention provides a piston and cylinder assembly suitable for use in positive displacement machines and capable of minimizing power losses resulting from friction and fluid leakage over a range of operating parameters.

According to a first aspect of the invention, a piston and cylinder assembly includes a piston reciprocably disposed within a cylinder having an axis, a cylindrical bearing surface and a uniform diameter. The piston has a bearing surface having an axial length and defining a diametrical clearance with the perimeter of the cylinder of up to about two percent of the diameter of the cylinder. The diametrical clearance defines a lubrication gap and a hydrodynamic seal between the piston and the cylinder. The piston further has alternating crests and valleys defined in a nominally cylindrical shape of its bearing surface. The crests and valleys are oriented perpendicular to an axial direction of the bearing surface and spaced in the axial direction to define a wavy surface form along the entire axial length of the bearing surface. The wavy surface form defines a crest-to-crest frequency in the axial direction and a crest-to-valley amplitude in a radial direction of the bearing surface.

According to a second aspect of the invention, a method is provided for reducing power losses of a positive displacement machine comprising a piston reciprocably disposed within a cylinder having an axis, a cylindrical bearing surface and a uniform diameter. The method includes forming the piston to comprise a bearing surface having an axial length and defining a diametrical clearance with the perimeter of the cylinder of up to about two percent of the diameter of the cylinder. The diametrical clearance defines a lubrication gap and a hydrodynamic seal between the piston and the cylinder. The method further includes defining alternating crests and valleys in a nominally cylindrical shape of the bearing surface of the piston. The crests and valleys are oriented perpendicular to an axial direction of the bearing surface and spaced in the axial direction to define a wavy surface form along the entire axial length of the bearing surface. The wavy surface form defines a crest-to-crest frequency in the axial direction and a crest-to-valley amplitude in a radial direction of the bearing surface.

A significant advantage of this invention is that the ability of the crests and valleys to create hydrodynamic buildup of pressure within the valleys and between the crests, which decreases power losses in the positive displacement machine.

Other aspects and advantages of this invention will be better appreciated from the following detailed description.

### BRIEF DESCRIPTION OF THE DRAWINGS

FIG. 1 schematically represents a piston and cylinder assembly of a variable displacement machine, the dynamics of a fluid film between the piston and cylinder, and the forces acting on the piston as it reciprocates within the cylinder.

FIG. 2 represents two types of pistons simulated in a first investigation leading up to the present invention.

FIG. 3 is a graph plotting the surface profiles and diametrical clearances of the pistons represented in FIG. 2 and of a third type of piston having a ribbed bearing surface.

FIG. 4 is a table indicating the relative diametrical clearances of the pistons represented in FIG. 3.

FIGS. 5 and 6 are graphs plotting the average gap flow with and without relative rotation for each simulation of the pistons represented in FIGS. 2 and 3.

FIGS. 7 and 8 are graphs comparing the axial work done on the pistons represented in FIGS. 2 and 3 in a single pump revolution with and without relative rotation for each simulation.

FIG. 9 is a graph comparing the tangential work done on the pistons represented in FIGS. 2 and 3 in a single pump revolution for each simulation.

FIG. 10 is a graph comparing the combined axial and tangential work done on the pistons represented in FIGS. 2 and 3 in a single pump revolution for each simulation.

FIG. 11 schematically represents a piston having an axially waved surface form superimposed on a nominally cylindrical shape of the piston in accordance with a particular embodiment of the invention.

FIGS. 12 through 27 are graphs plotting results obtained with simulations performed with pistons of the type represented in FIG. 11.

### DETAILED DESCRIPTION OF THE INVENTION

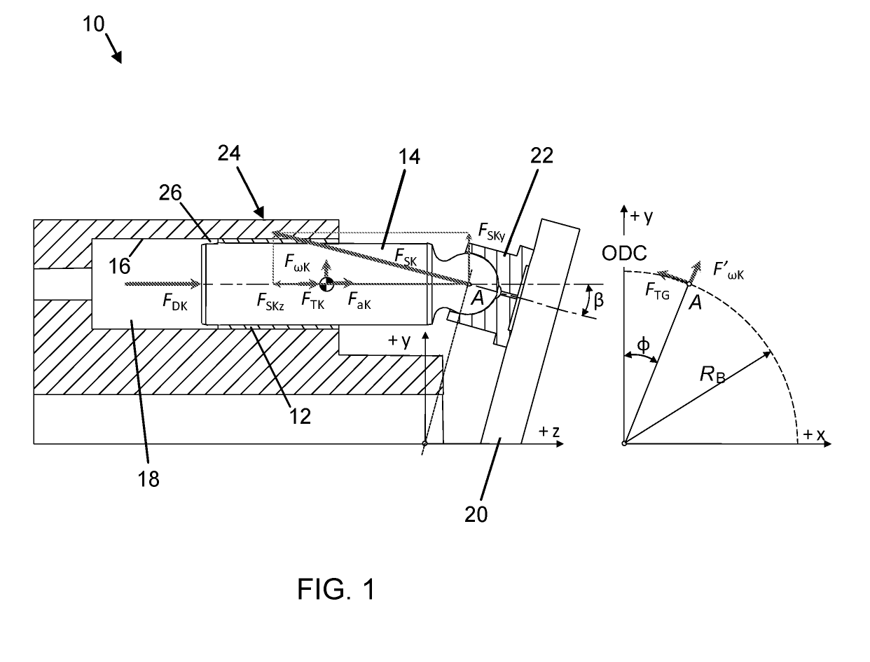

FIG. 1 schematically represents a piston and cylinder assembly of a variable displacement machine 10 of a type known in the art. FIG. 1 is drawn for purposes of clarity when viewed in combination with the following description, and therefore is not necessarily to scale. In addition to the basic components of the machine 10, FIG. 1 represents the dynamics of a fluid film 12 between the piston 14 and cylinder 16 of the piston and cylinder assembly and forces acting on the piston 14 as it reciprocates within the cylinder 16. The axes of the piston 14 and cylinder 16 generally coincide, and the bearing surfaces of the piston 14 and cylinder 16 are cylindrical and of uniform diameter, consistent with standard industry practices. In addition to its bearing surface, the piston 14 has a protruding end configured to achieve a ball-and-socket arrangement with a socket formed on a slipper 22, which has a planar surface that bears against a swash plate 20. Pressurized fluid within the displacement chamber 18 puts an axial force (F_{DK}) on the piston 14, which is counteracted by a force (F_{SK}) applied to the piston 14 by the swash plate 20. The piston 14 is also loaded by inertial force (F_{aK}), an axial friction force (F_{TK}) applied to the piston 14 by the surface of the cylinder 16, a centrifugal force (F_{ωK}), and a friction force (F_{TG}) on the slipper 22.

Except for the centrifugal force (F_{ωK}) and assuming steady state conditions, the forces shown in FIG. 1 are all dependent upon the angle of rotation (φ) of the machine 10. These forces vary with machine rotation because of the pump kinematics and the changing pressure in the displacement chamber 18. The result is that the piston 14 moves from outer dead center (ODC) to inner dead center (IDC) and back to ODC over one revolution of the cylinder block 24 containing the cylinder 16 and its piston 14. As understood in the art, the cylinder block 24 contains a number of piston and cylinder assembles (not shown) similar to the one shown, and these assemblies are typically in a circular array that is coaxial with the rotational axis (the +z axis in FIG. 1) of the block 24. The motion induced in the piston 14 by the rotation of the block 24 is referred to herein as the macro motion of the piston 14. The piston 14 also undergoes what will be termed as micro motion due to the changing forces, resulting in the piston 14 pitching within the cylinder 16. The inclination of the piston 14 relative to the cylinder 16 is due primarily to the y-component of the swash plate reaction force (F_{SKy}), which causes the gap 26 formed by the diametrical clearance between the piston 14 and cylinder 16 to have a nonuniform and varying gap height in both the axial and circumferential directions. Because F_{SK} is a function of the angular position φ of the cylinder block 24, the gap height between the piston 14 and cylinder 16 is a function of φ.

The gap 26 between the piston 14 and cylinder 16 is very small, typically on the order of 2% or less of the diameter of the cylinder 16 and on the order of about 0.03 mm or less for typical positive displacement machine designs. The gap 26 allows fluid flow from the displacement chamber 18 to the exterior of the cylinder block 24. Pressure builds up in the gap 26 because the cylindrical bearing surfaces of the piston 14 and cylinder 16 are moving relative to each other, the bearing surfaces are not parallel to each other, and the fluid is viscous. This pressure field performs two important functions: it provides the reaction force necessary to support the piston 14 so that mixed friction is avoided, and it helps seal the gap 26 so that leakage from the displacement chamber 18 is minimized. Since the gap height is a function of φ, the pressure field between the piston 14 and the cylinder 16, the flow velocity, the resulting viscous friction, and the gap flow are also dependant on φ. More details can be found in Wieczorek and Ivantysynova, Computer Aided Optimization of Bearing and Sealing Gaps in Hydrostatic Machines—The Simulation Tool CASPAR, International Journal of Fluid Power, Vol. 3, No. 1, pp. 7-20 (2002), whose contents are incorporated herein by reference.

In an investigation leading to the invention, two advanced gap flow models for axial piston machines were employed. Both models utilized the CASPAR simulation tool reported in Wieczorek and Ivantysynova (2002), supra, considered the instantaneous displacement chamber pressure and the micro and macro motion of the piston, and solved the Reynolds equation for the resulting gap flow. One of the models considered the surface deformation of the piston and cylinder bore, while the other (referred to as the rigid model) did not. Both models were used to predict the axial and tangential friction forces exerted on the cylinder of an axial piston machine at multiple operating conditions. The simulation results were then compared with measurement results obtained from an experimental pump.

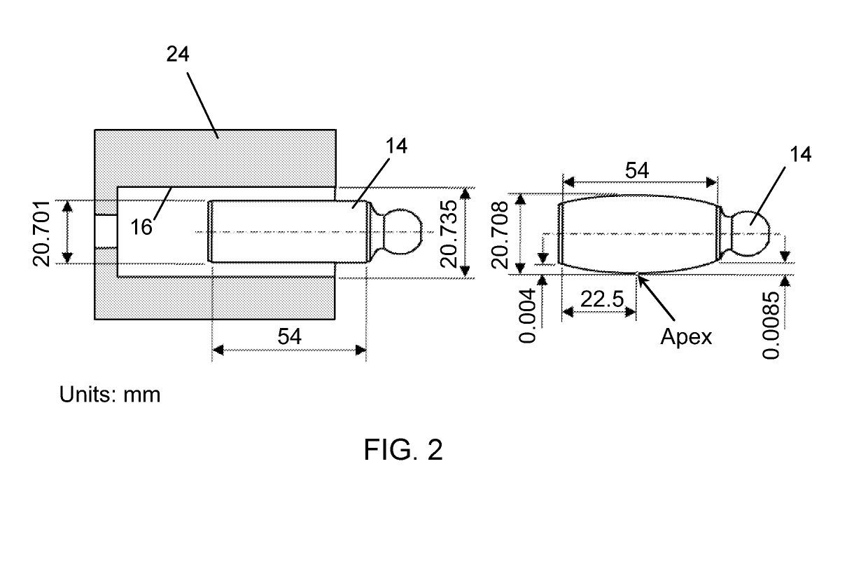

Three piston designs were simulated during the investigation. As represented on the lefthand side of FIG. 2, one of the piston designs was a conventional piston of the type shown in FIG. 1, and whose entire bearing surface was cylindrical. A second piston design had a barrel-shaped bearing surface represented on the righthand side of FIG. 2, and was chosen on the basis of prior research that indicated the design is capable of reducing energy dissipation in the piston/cylinder gap by decreasing both the leakage through the gap and the friction force on the piston over a wide range of operating parameters. These piston designs were simulated to have the dimensions indicated in FIG. 2, and simulated to reciprocate in a cylinder of a cylinder block whose pertinent simulated dimensions are also indicated in FIG. 2.

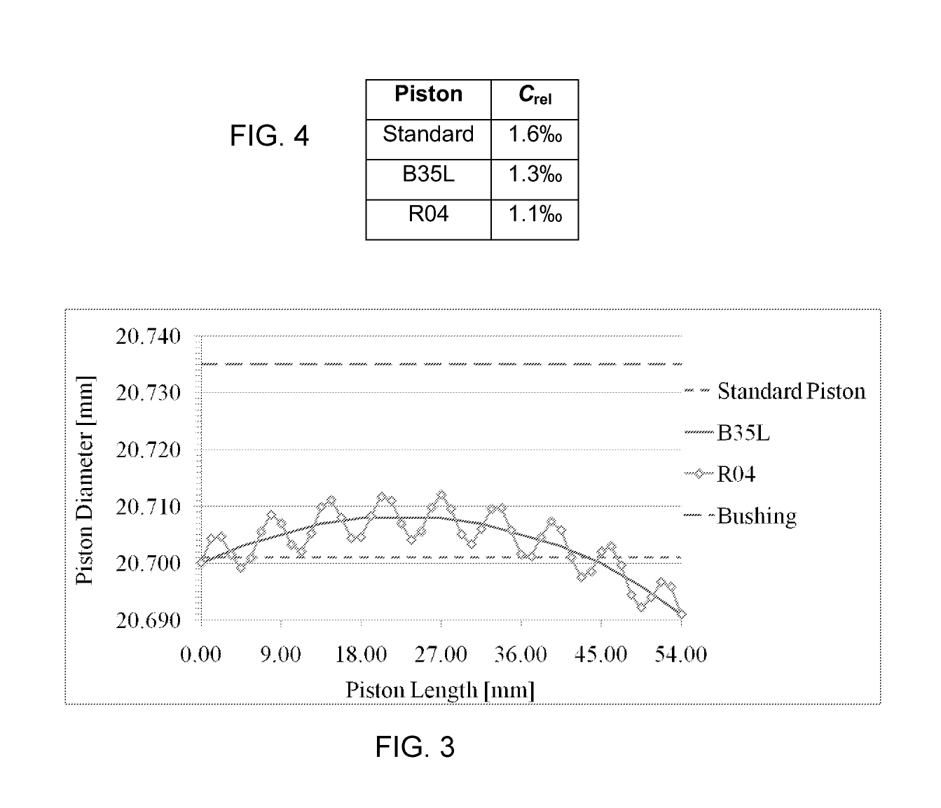

The bearing surface profiles of the first and second simulated piston designs and the bearing surface profile of the simulated cylinder (“bushing”) are represented in the graph of FIG. 3. The first piston design is referred to as the “standard” piston, and the second piston design is referred to as the “B35L” piston. FIG. 3 also plots a third piston design whose bearing surface was barrel-shaped similar to the second piston, but further modified to have ribs lying in planes perpendicular to the piston axis. The third piston design is referred to as the “R04” piston and, except for the ribs, has the same barrel-shaped profile as the B35L piston. The R04 was simulated to have ribs with an amplitude of two micrometers (measured with respect to the B35L surface). Because the ribs are continuous around its entire circumference, the R04 piston had a maximum diameter of four micrometers larger than the maximum diameter of the B35L piston. Due to a smaller diametrical clearance with the bearing surface of the cylinder, the R04 piston was expected to have less leakage. The relative clearances of the simulated pistons are shown in FIG. 4, and were computed with the equation

Cᵣₑₗ=(d_{B}−d_{K})/d_{B}·100%

where d_{B} is the inner diameter of the bushing and d_{K} is the largest outer diameter of the piston.

The R04 piston was investigated for the purpose of studying a piston design that might be capable of lowering energy dissipation in a variable displacement machine, thereby increasing machine efficiency. An ideal design would decrease the gap flow (leakage) while at the same time decreasing viscous friction in the gap, and do so over a wide range of operating parameters. Achieving each of these goals is a difficult task, because leakage and friction are typically inversely proportional: leakage can be decreased by decreasing the clearance between the piston and cylinder, but will increase the viscous friction and could in fact lead to mixed friction. Accordingly, the investigation was not intended to identify an optimum piston design, but rather to evaluate a different piston design and characterize its performance.

The following parameters were simulated for each of the three pistons to obtain an understanding of how the designs compare to each other over a broad range of operating parameters: differential pressures of 100 and 400 bar (10 and 40 MPa); cylinder block rotational speeds of 1000 and 3000 rpm; and 20% and 100% displacement. Also simulated was relative rotation and no relative rotation of the piston within the cylinder. A 100% displacement means that the simulated swash plate angle is at its maximum and the piston has the largest stroke possible. A 20% displacement indicates the piston has a relatively short stroke and displaces less fluid per revolution of the pump. When relative rotation is considered in a simulation, the piston was assumed to rotate a full 360 degrees relative to the cylinder for each rotation of the cylinder block. Previous investigations had confirmed that pistons do have relative rotation in a standard pump, though it is uncertain how far the pistons will actually rotate per revolution of the cylinder block. The possible combinations of parameters with the three piston designs yielded a total of forty-eight simulations.

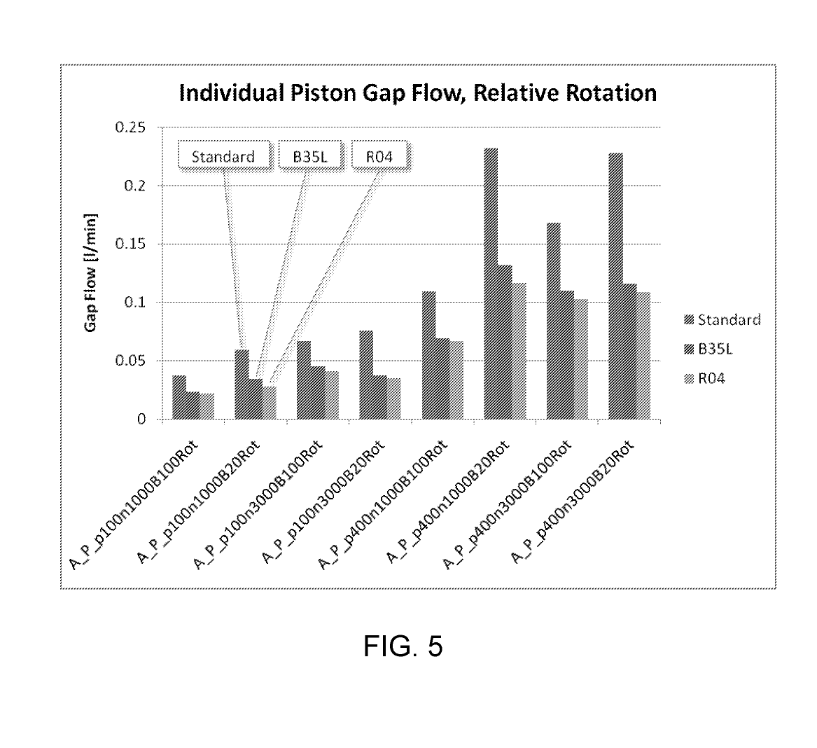

Simulations were named with the following naming convention. Using “A_P_p100n1000B20_Std_Rot” as an example, A identifies the pump, P identifies a pumping mode (M identifies a motoring mode), p identifies the pressure (in bars), n identifies the cylinder block rotational speed (in rpms), and B identifies the pump displacement (in percent). Finally, “Rot” identifies that piston rotation was simulated, whereas “NoRot” identifies that piston rotation was not simulated. The simulated pump “A” was a 75 cc unit that can be run in pumping or motoring mode, though all simulations were run in pumping mode (“P”). Results of the simulations represented in FIGS. 5 through 10 are for simulations completed with the rigid CASPAR model.

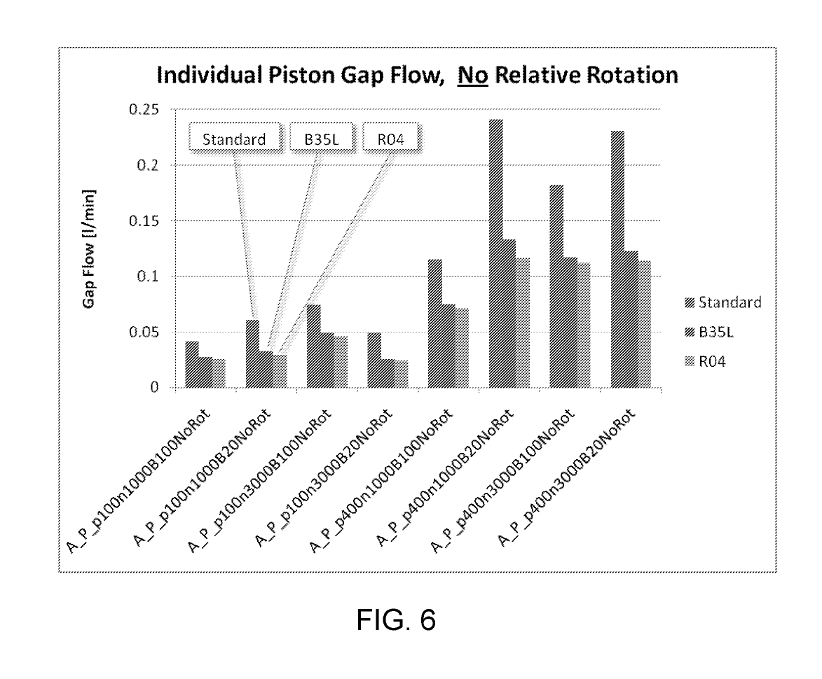

The average gap flow for each simulation with relative piston rotation is shown in FIG. 5 and for each simulation without relative rotation in FIG. 6. Simulation results represented in FIGS. 5 and 6 evidenced that the B35L piston was predicted to have substantially lower leakage than the standard piston, and the R04 piston would decrease leakage even further. Leakage increased if there was no simulated piston rotation, but differences between piston designs did not change much. FIG. 5 further indicates that the improvements obtained with the R04 piston were greater at low displacements (20%), and most pronounced when the piston was subjected to high pressure (400 bar). The results at high pressure (400 bar) and high speed (3000 rpm) at low displacement (20%) were basically analogous to those at low pressure (100 bar) and low speed (1000 rpm) at low displacement (20%), but in this case the leakage did not increase nearly as much when there is no piston rotation. From FIGS. 5 and 6, it was evident that the R04 was predicted to decrease leakage under all simulated conditions, as was expected because the R04 piston was simulated to have a smaller diametrical clearance than the standard and B35L pistons. Using the average leakages, the percent decrease in leakage was calculated for the R04 compared to the standard piston as well as compared to the B35L, from which it was seen that the biggest decrease in leakage was at low displacements (20%).

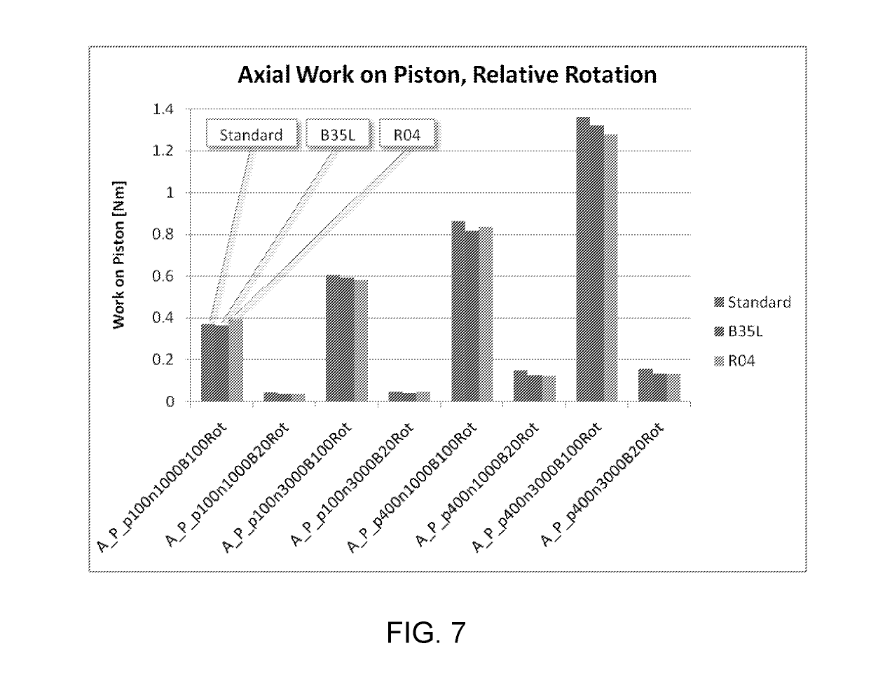

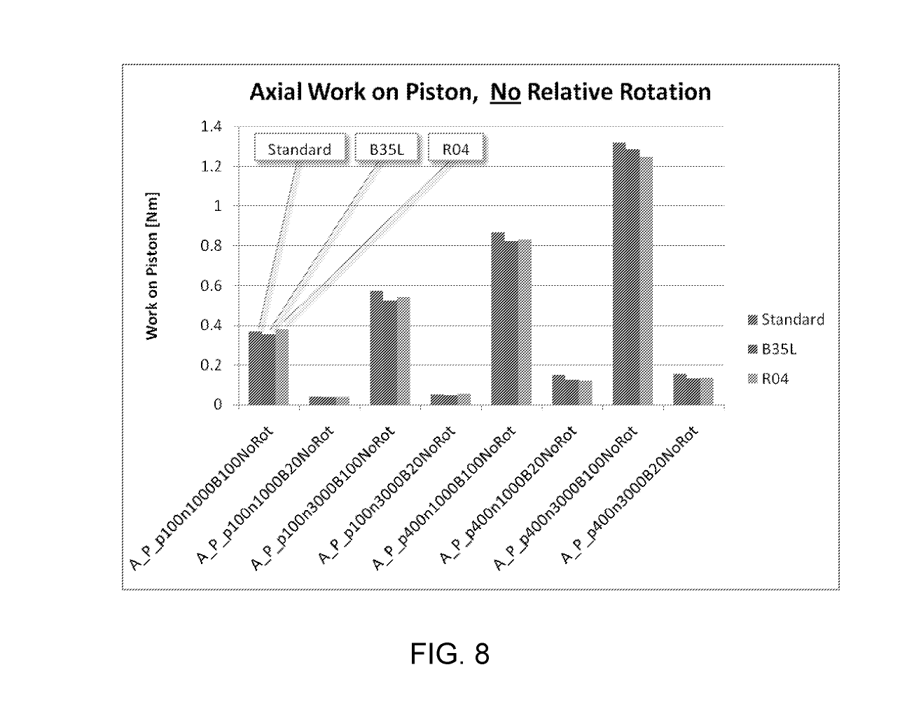

The axial work done on the simulated pistons in a single pump revolution is compared for each simulation with relative rotation in FIG. 7, and each simulation without relative rotation in FIG. 8. For most cases, the R04 piston decreased the work done on the piston in the axial direction compared to the standard, but not to the extent of the B35L piston. Compared to the standard, the R04 performed best at low displacement (20%) and high pressure (400 bar).

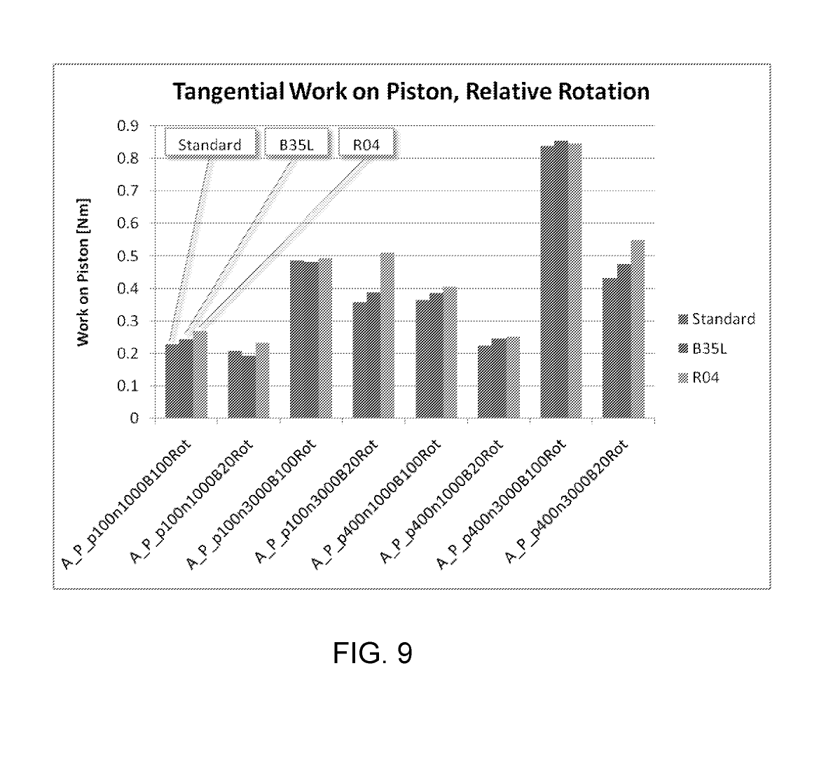

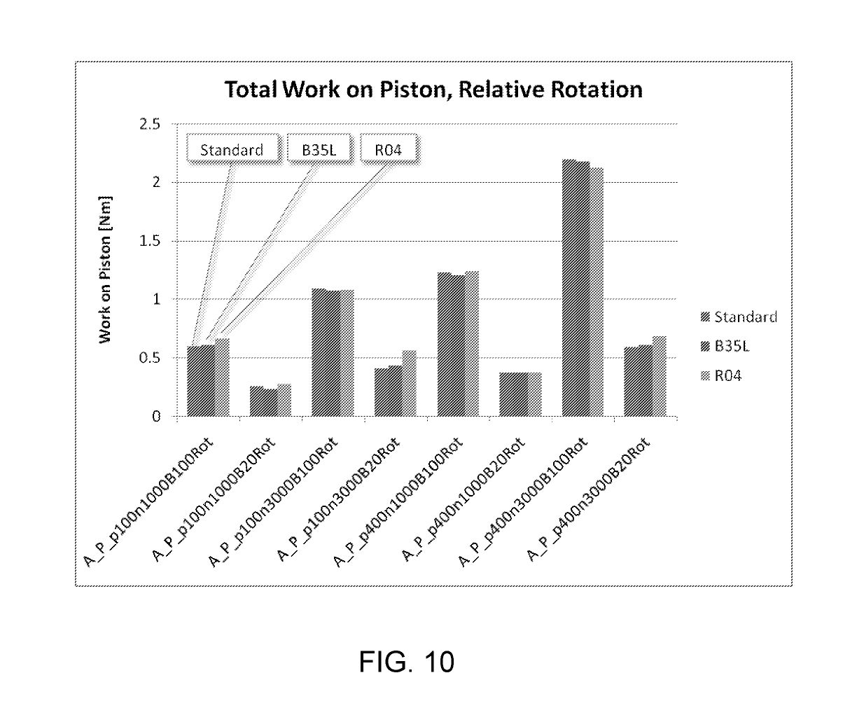

The tangential work done on the simulated pistons in one pump revolution is compared for each simulation in FIG. 9. In general, the standard piston had the lowest work, followed by the B35L, and then the R04 piston. The R04 piston had the smallest increase in work at high displacement (100%). To determine whether the R04 piston increased or decreased overall losses due to viscous friction, the work from both the axial and tangential friction forces was totaled. FIG. 10 shows that when relative piston rotation was simulated, the R04 piston did not perform as well as the B35L piston. When there is no relative rotation, the totals were the same as the values displayed in FIG. 8, since work is only done in the axial direction.

The trend seen from FIGS. 5 to 10 was that, in general, the R04 piston decreased the work due to friction compared to the standard piston if there is no relative rotation of the piston. This decrease tended to be largest at low displacement (20%). Compared to the B35L piston, the R04 was better in a few cases at high pressure (400 bar), though inferior in other cases. In addition, the R04 piston exhibited lower leakage than both the standard and B35L pistons, and the greatest improvement was predicted for low displacement (20%). In summary, the R04 piston simulation produced some interesting results, and it was concluded that improvements might be achieved by introducing modifications.

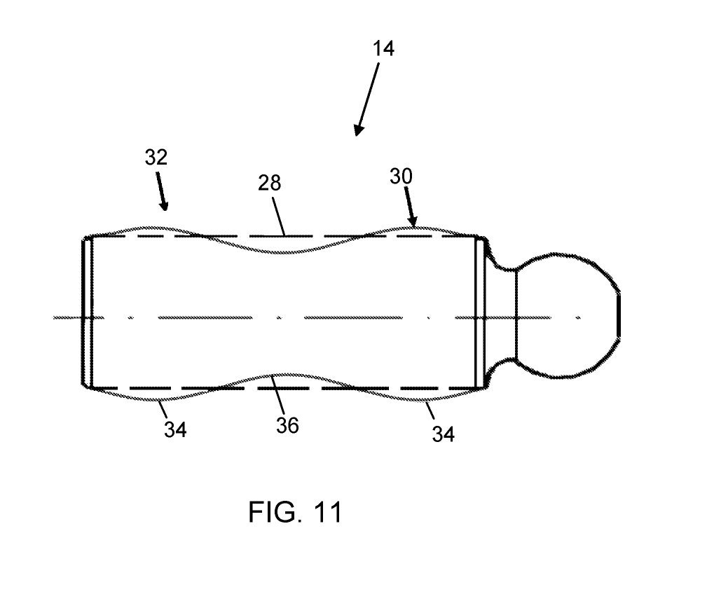

Based on the results of the investigation described above, further simulations were performed to evaluate the effect of a wavy surface form on pistons of the type used in variable displacement machines. FIG. 11 schematically depicts such a piston 14, which is intended to replace the piston 14 of the piston and cylinder assembly shown in FIG. 1 without any required modifications to the remainder of the machine 10. The piston 14 has a bearing surface 30 with a nominally cylindrical shape 28 (similar to the cylindrical bearing surface of the piston 14 in FIG. 1 and the standard piston simulated in the previous investigation). However, the piston 14 of FIG. 11 is shown to have an axially wavy surface form 32 superimposed in the cylindrical shape 28. The particular example shown in FIG. 11 is of a piston 14 with a periodic waveform of two crests 34 separated by a valley 36, such that the wavy surface form 32 contains 1.5 periods on the bearing surface 30 of the piston 14. The piston bearing surface 30 can be seen in FIG. 11 to be entirely defined by the wavy surface form 32. The wavy surface form 32 is exaggerated in FIG. 11 for pictorial purposes and therefore not to scale.

To simulate pistons of the type used in a variable displacement machine, the piston and cylinder dimensions identified in FIG. 2 were again used in this simulation. The number of crests and the amplitude of the waves were varied as follows—number of crests: 2 (“2 Rib”), 4 (“4 Rib”) or 8 (“8 Rib”); and crest amplitude: ±2 (“2_microns”), ±6 (“6_microns”) or ±14 micrometers (“14_microns”), corresponding to crest-to-valley amplitudes of 4, 12 and 28 micrometers, respectively. These variables resulted in nine different pistons to be simulated, which was performed with the CASPAR simulation tool used in the previous investigation. The nine pistons were simulated under the same conditions as used in the previous investigation, namely, a speed of 1000 or 3000 rpm, a pressure differential of 100 or 400 bar (10 or 40 MPa), and a displacement of 20% or 100%. These conditions were simulated both in pumping and motoring mode to yield 160 simulations.

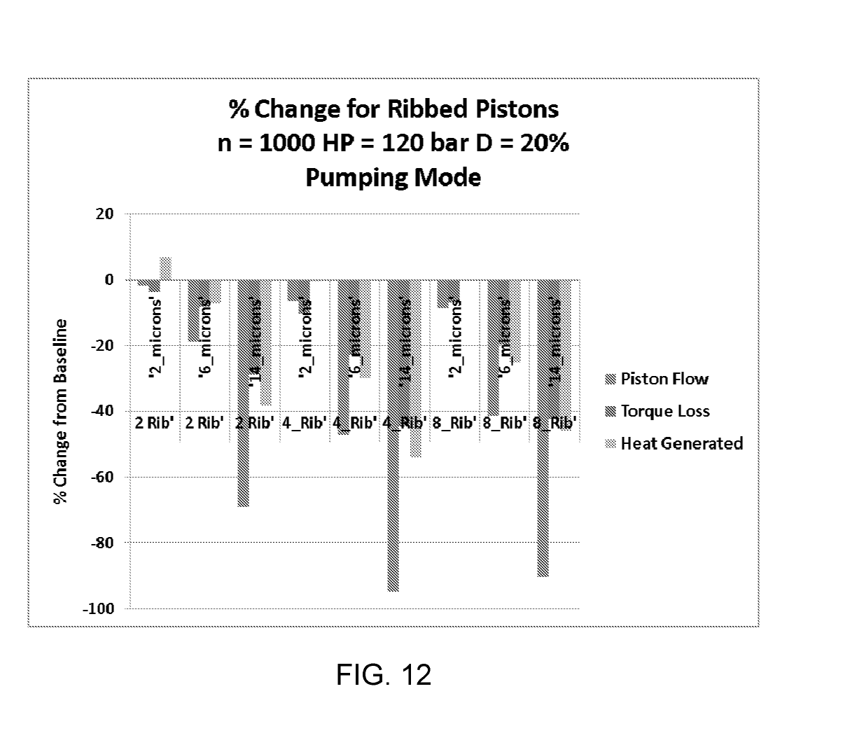

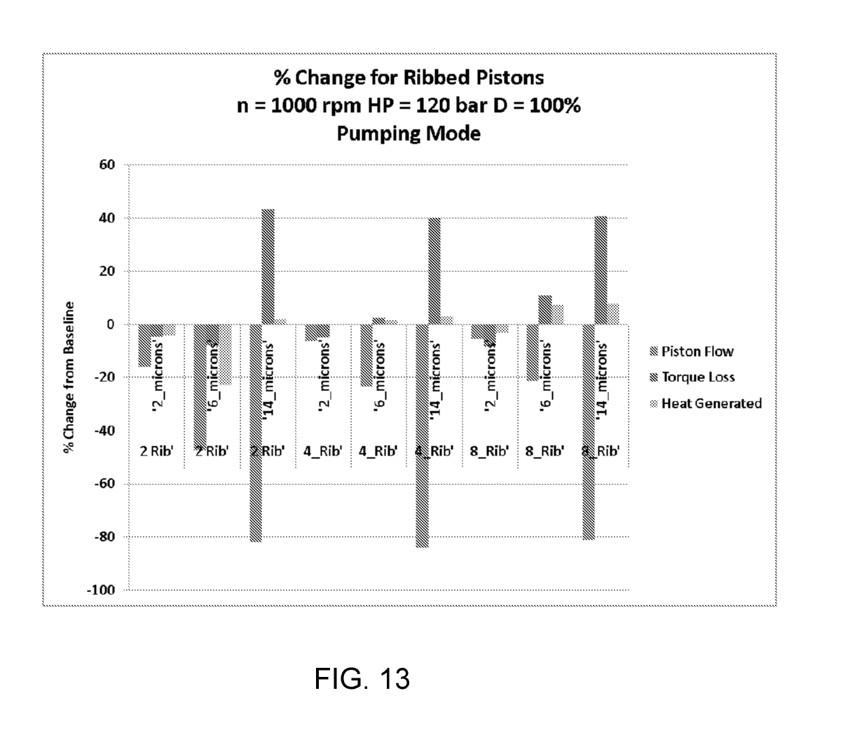

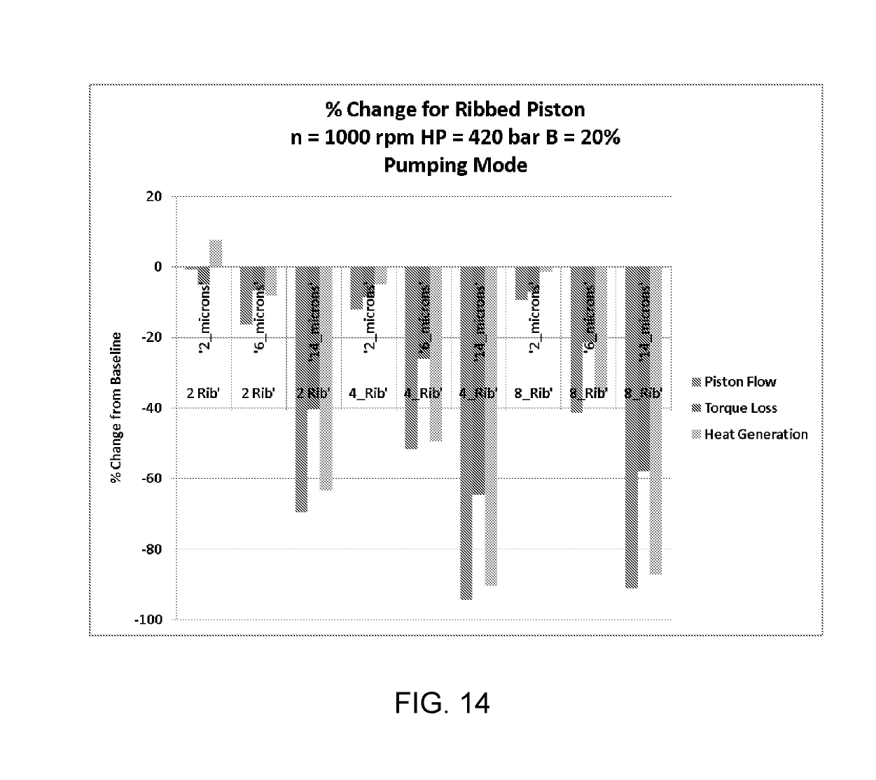

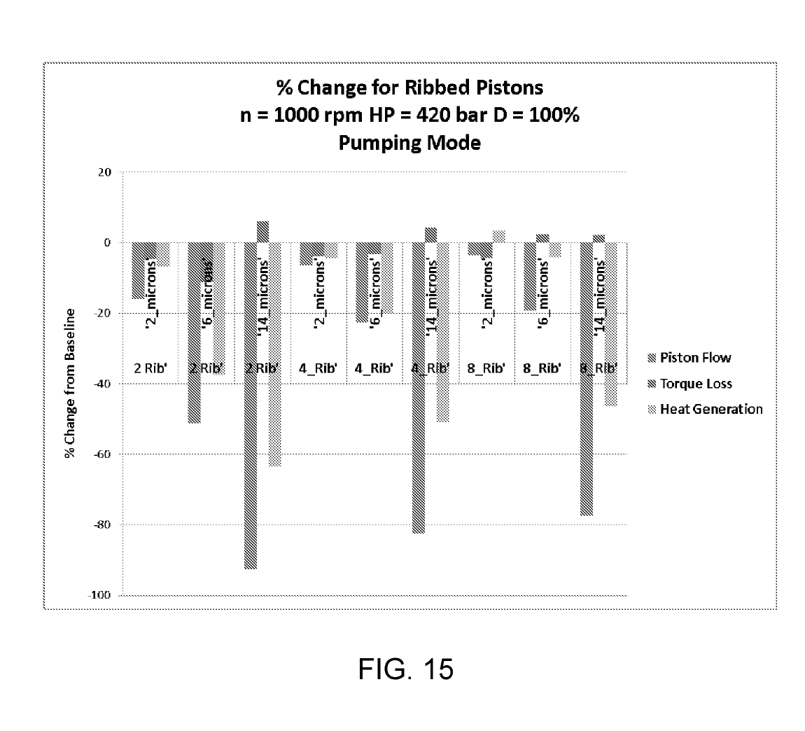

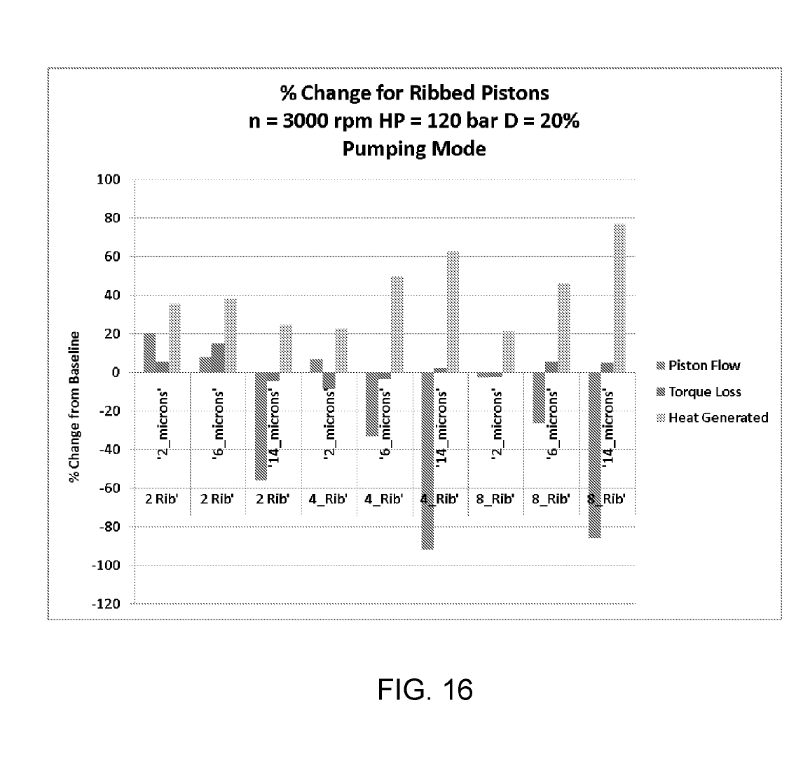

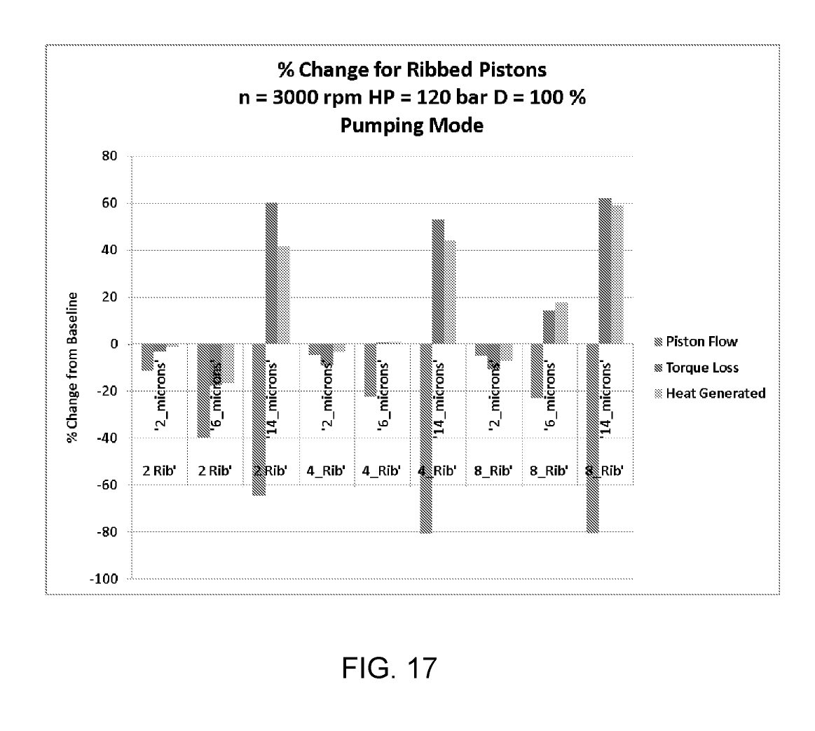

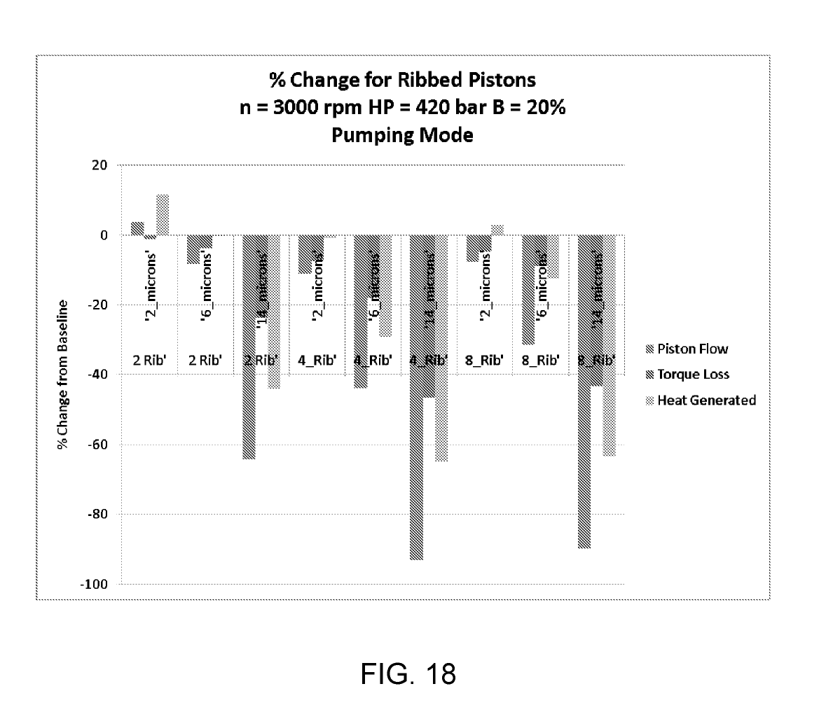

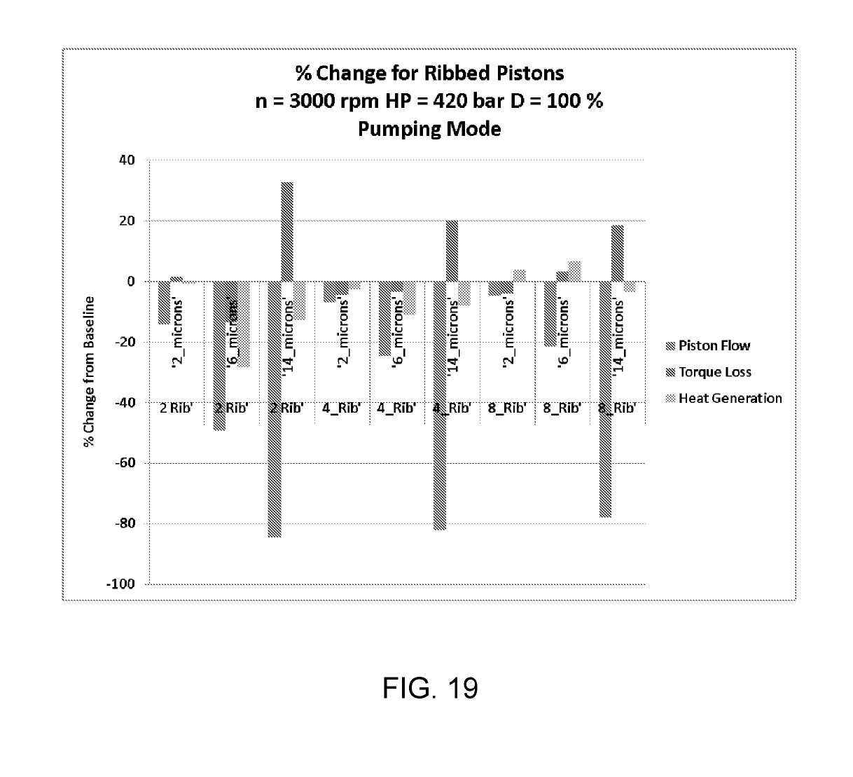

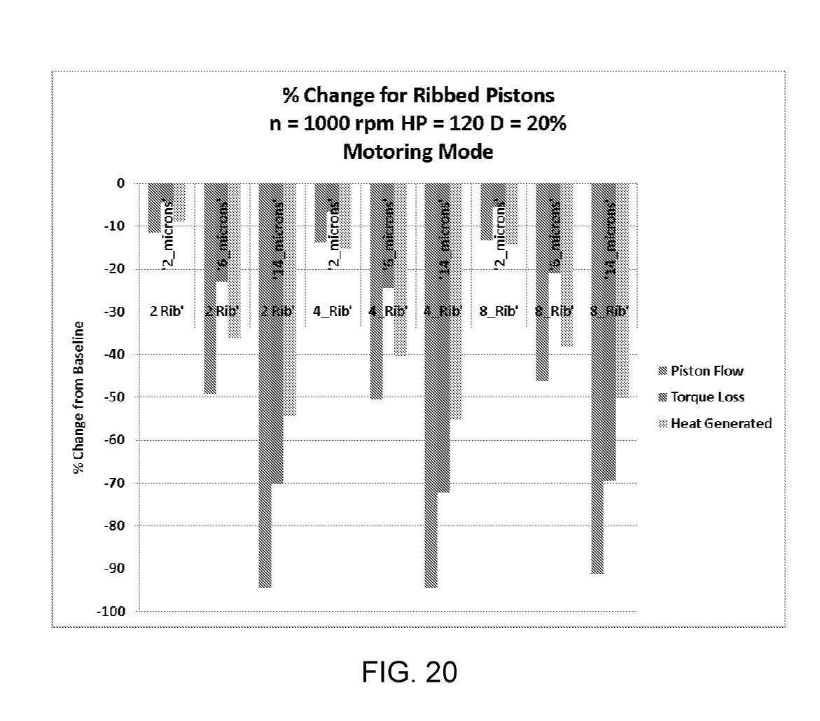

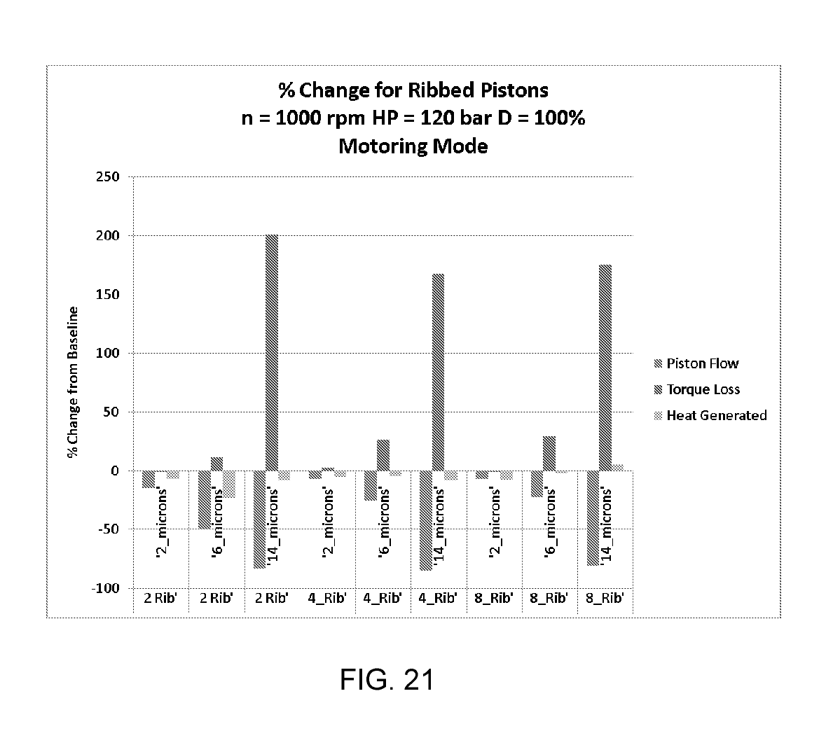

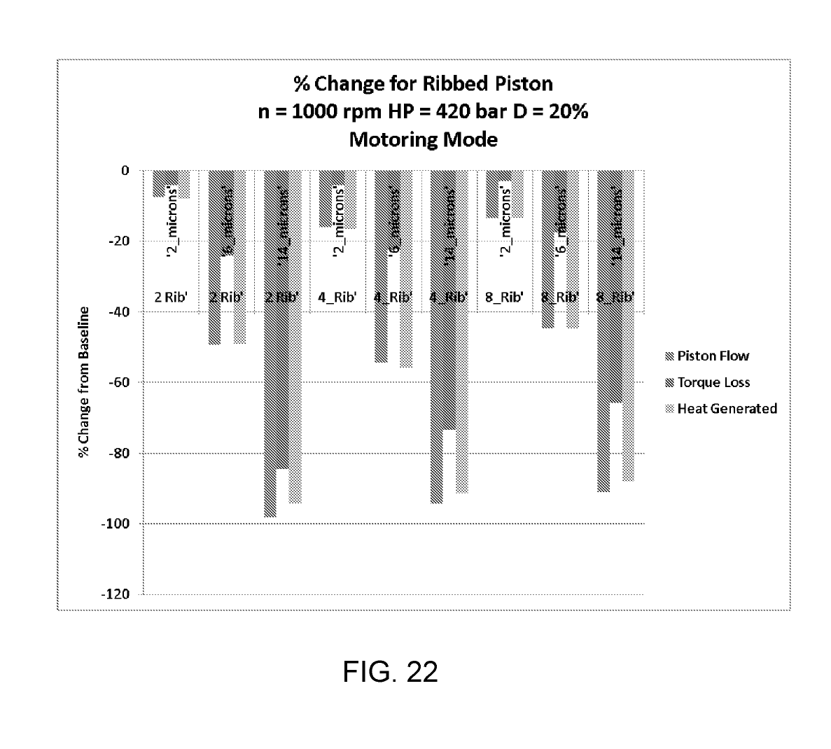

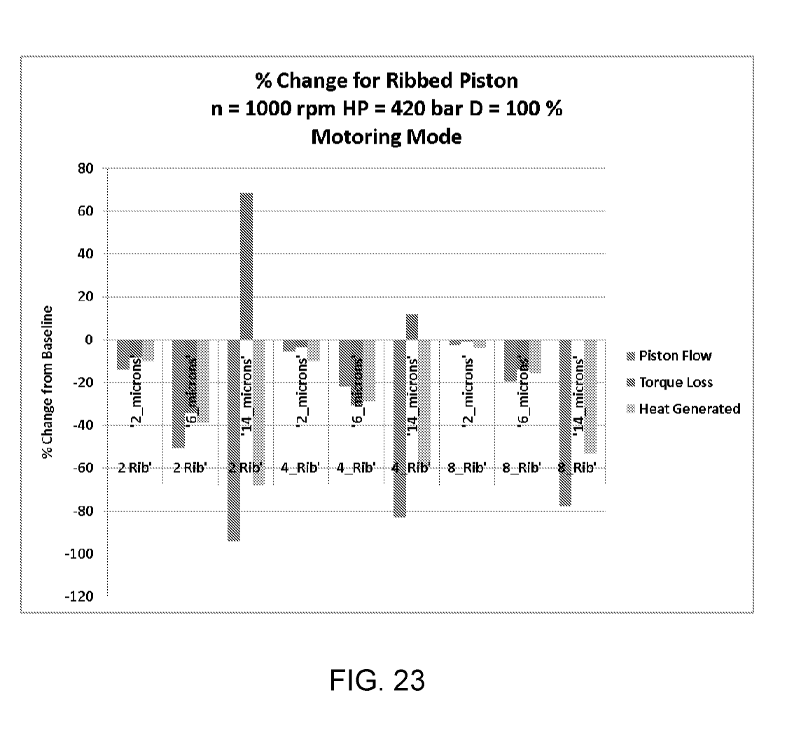

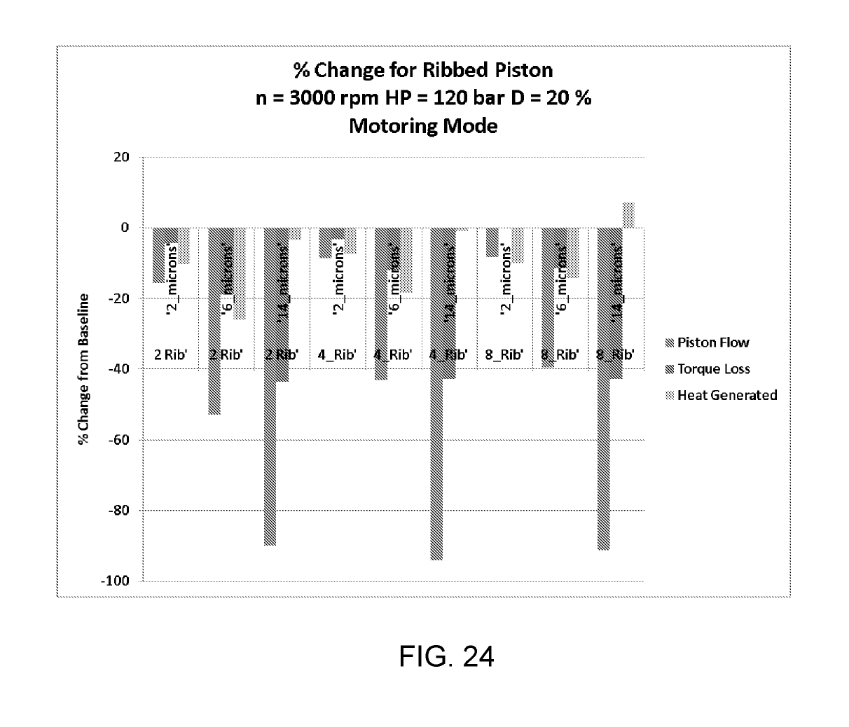

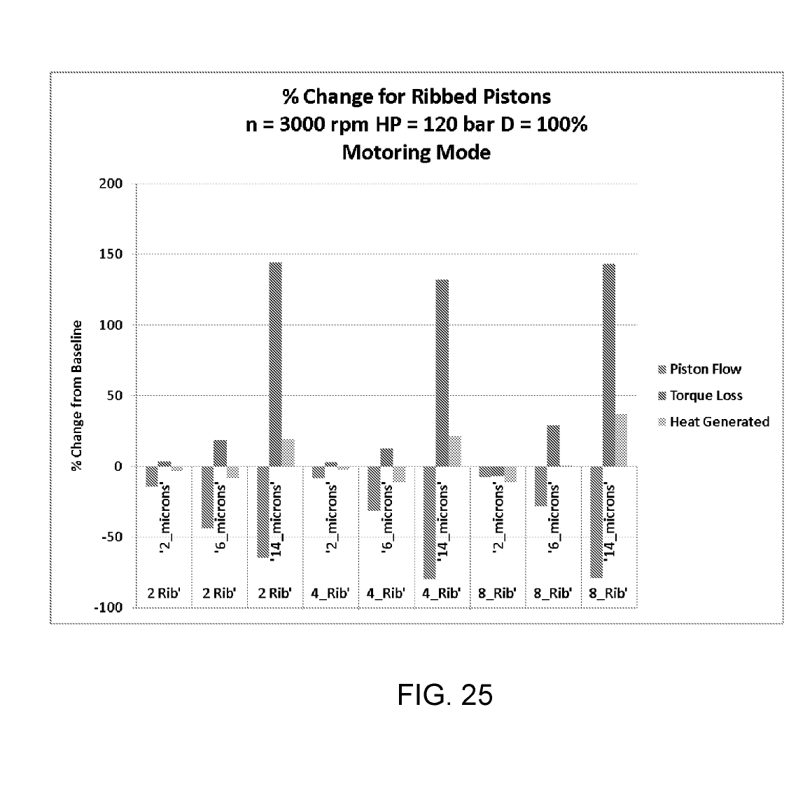

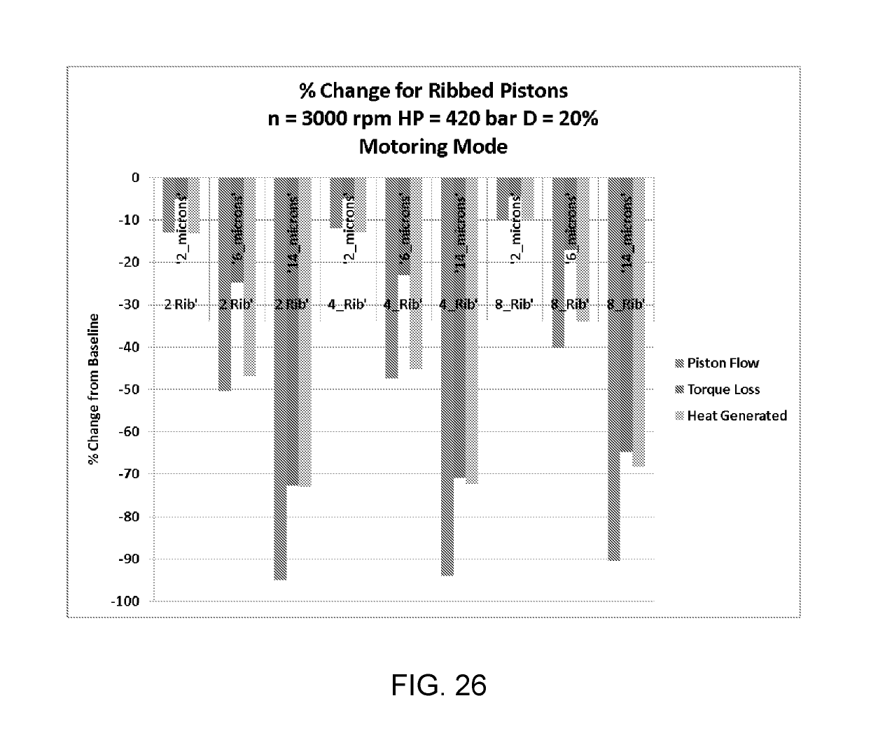

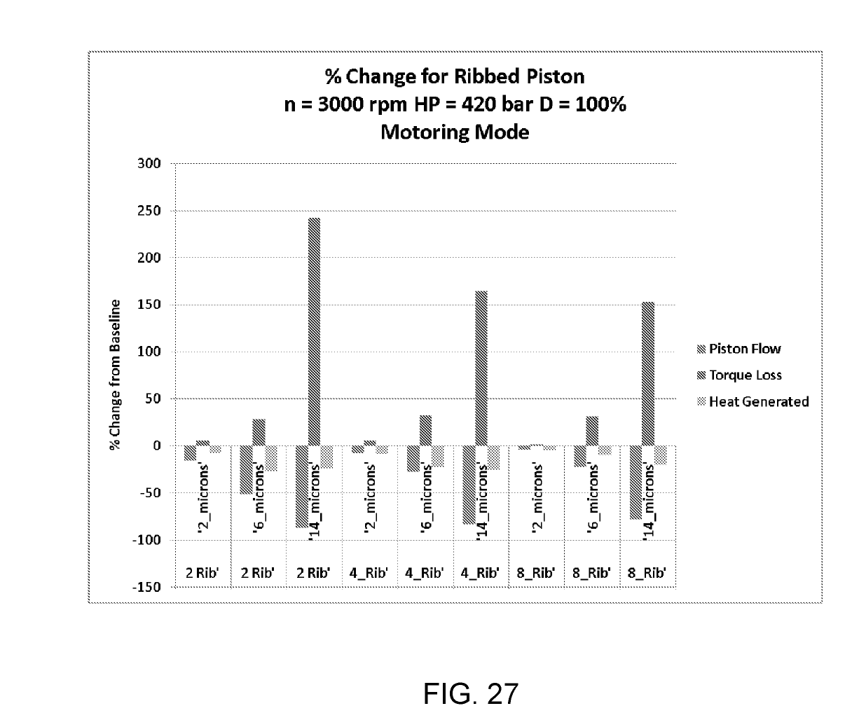

FIGS. 12 through 27 are graphs plotting the simulated results using the CASPAR tool. The graphs show the percent changes in performance of the piston 14 of FIG. 11 relative to a conventional cylindrical piston identical to the simulated standard piston of the previous investigation. The graphs give the average of the piston leakage, the torque loss due to viscous friction, and the heat generated due to fluid shear over one shaft revolution of the machine. The simulation data evidenced that reductions in leakage, torque loss and heat generated can be achieved with the piston 14 simulated to have a bearing surface 30 with a wavy surface form 32. The simulation results of FIGS. 12 through 27 were concluded to evidence that a piston with a wavy surface form is capable of decreasing the power loss in axial piston pumps and motors by creating additional hydrodynamic build up of pressure between crests, which changes the flow characteristics within the lubricating gap between the piston and cylinder. The simulation data of FIGS. 12 through 27 further indicated that pistons with two crests (1.5 waveform periods on the bearing surface) and an amplitude of ±6 micrometers (crest-to-valley amplitude of 12 micrometers) reduced energy loss over the widest range of operating conditions.

For use in a variable displacement machine, typical dimensions for the piston 14 of FIG. 11 will be on the order of one millimeter to several centimeters. Based on the simulations, it was concluded that the crest-to-valley (peak-to-peak) amplitude should be at least two orders of magnitude less than the diameter of the piston 14, more preferably three orders of magnitude less than the diameter of the piston 14 (based on the nominally cylindrical shape of the bearing surface 30). For example, for a piston diameter of about twenty millimeters, the crest-to-valley amplitude should be less then one hundred micrometers and more preferably less than twenty micrometers. Furthermore, a suitable wavelength for the periodic wave form is believed to be up to about three to four centimeters, or a frequency at least 0.3/cm of bearing surface axial length. As particular examples, for a piston having a nominally cylindrical bearing surface having the simulated axial length of about 54 mm and diameter of about 20 mm, a suitable number of crests is believed to be 2 to about 200 and a suitable range for wave amplitudes in the axial direction is believed to be ±0.2 to about ±200 micrometers (crest-to-valley amplitudes of 0.4 to 400 micrometers) relative to the nominally cylindrical profile of the bearing surface 30. The simulated wavy surface form 32 shown in FIG. 11 is a sinusoidal (symmetric) waveform, though other periodic wave forms are foreseeable. It is also foreseeable that nonperiodic and/or asymmetric wave forms could be adopted. While the simulation investigated crests and valleys lying in planes perpendicular to the axis of the piston, another possibility is to orient the wave form so that the crests and valleys are parallel to the axis of the piston. Also any combination of waves in the axial or circumferential may be effective.

While the invention has been described in terms of a specific embodiment, it is apparent that other forms could be adopted by one skilled in the art. For example, the physical configuration of the piston and cylinder could differ from that shown, and materials and processes other than those noted could be used. Therefore, the scope of the invention is to be limited only by the following claims.

1. A piston and cylinder assembly of a positive displacement machine, the assembly comprising a piston reciprocably disposed within a cylinder having an axis, a cylindrical bearing surface and a uniform diameter, the piston comprising:
a bearing surface having an axial length and defining a diametrical clearance with the cylindrical bearing surface of the cylinder of up to about two percent of the diameter of the cylinder, the diametrical clearance defining a lubrication gap and a hydrodynamic seal between the piston and the cylinder; and
alternating crests and valleys defined in a nominally cylindrical shape of the bearing surface of the piston, the crests and valleys being oriented and spaced on the bearing surface to define a wavy surface form along the entire axial length of the bearing surface, the wavy surface form defining a crest-to-crest frequency and a crest-to-valley amplitude, the crests and valleys creating hydrodynamic buildup of pressure within the valleys and between the crests that decreases power losses in the positive displacement machine.

2. The piston and cylinder assembly according to claim 1, wherein the crests and valleys are oriented perpendicular to an axial direction of the bearing surface and are spaced in the axial direction along the entire axial length of the bearing surface.

3. The piston and cylinder assembly according to claim 1, wherein the diameter of the cylinder is up to about two centimeters and the diametrical clearance between the bearing surface of the piston and the cylindrical bearing surface of the cylinder is up to about 0.03 millimeter.

4. The piston and cylinder assembly according to claim 1, wherein the crest-to-crest frequency of the wavy surface form is at least 0.3 per centimeter.

5. The piston and cylinder assembly according to claim 1, wherein the crest-to-valley amplitude of the wavy surface form is at least three orders of magnitude less than the diameter of the piston.

6. The piston and cylinder assembly according to claim 1, wherein the crest-to-valley amplitude of the wavy surface form is about 0.4 to about 400 micrometers.

7. The piston and cylinder assembly according to claim 1, wherein the crest-to-valley amplitude of the wavy surface form is about 4 to about 28 micrometers.

8. The piston and cylinder assembly according to claim 1, wherein the wavy surface form is a sinusoidal waveform.

9. The piston and cylinder assembly according to claim 1, wherein the piston and cylinder assembly lacks a sealing means within the diametrical clearance between the piston and the cylinder other than the hydrodynamic seal defined by the diametrical clearance.

10. The piston and cylinder assembly according to claim 1, wherein the piston and cylinder assembly is installed in the positive displacement machine.

11. The piston and cylinder assembly according to claim 10, wherein the positive displacement machine is operating to cause the axis of the piston to be inclined relative to the axis of the cylinder as the piston reciprocates within the cylinder.

12. The piston and cylinder assembly according to claim 10, wherein the positive displacement machine is operating to cause the piston to reciprocate within the cylinder at a rate of up to at least 3000 cycles per minute.

13. The piston and cylinder assembly according to claim 10, wherein the positive displacement machine is operating to cause the piston to reciprocate within the cylinder and draw and expel a fluid from the cylinder and generate a pressure differential in the fluid of up to at least 40 MPa.

14. The piston and cylinder assembly according to claim 10, wherein the positive displacement machine is an axial piston pump.

15. The piston and cylinder assembly according to claim 10, wherein the positive displacement machine is an axial piston motor.

16. The machine according to claim 10, wherein the positive displacement machine comprises a cylinder block adapted to be rotated about an axis thereof, the cylinder is one of a plurality of cylinders defined in the cylinder block and surrounding the axis, the piston is one of a plurality of pistons reciprocably disposed within the cylinders, and a fluid enters and exits the cylinders as the pistons reciprocate within the cylinders, the fluid providing a fluid film within the lubrication gap and the hydrodynamic seal between the pistons and the cylinders.

17. A method of reducing power losses of a positive displacement machine comprising a piston reciprocably disposed within a cylinder having an axis, a cylindrical bearing surface and a uniform diameter, the method comprising:
forming the piston to comprise a bearing surface having an axial length and defining a diametrical clearance with the cylindrical bearing surface of the cylinder of up to about two percent of the diameter of the cylinder, the diametrical clearance defining a lubrication gap and a hydrodynamic seal between the piston and the cylinder; and
defining alternating crests and valleys in a nominally cylindrical shape of the bearing surface of the piston, the crests and valleys being oriented and spaced on the bearing surface to define a wavy surface form along the entire axial length of the bearing surface, the wavy surface form defining a crest-to-crest frequency and a crest-to-valley amplitude, the crests and valleys creating hydrodynamic buildup of pressure within the valleys and between the crests that decreases power losses in the positive displacement machine.

18. The method according to claim 17, wherein the crests and valleys are oriented perpendicular to an axial direction of the bearing surface and are spaced in the axial direction along the entire axial length of the bearing surface.

19. The method according to claim 17, wherein the diameter of the cylinder is up to about two centimeters and the diametrical clearance between the bearing surface of the piston and the cylindrical bearing surface of the cylinder is up to about 0.03 millimeter.

20. The method according to claim 17, wherein the crest-to-crest frequency of the wavy surface form is at least 0.3 per centimeter.

21. The method according to claim 17, wherein the crest-to-valley amplitude of the wavy surface form is at least three orders of magnitude less than the diameter of the piston.

22. The method according to claim 17, wherein the crest-to-valley amplitude of the wavy surface form is about 0.4 to about 400 micrometers.

23. The method according to claim 17, wherein the crest-to-valley amplitude of the wavy surface form is about 4 to about 28 micrometers.
